(19) United States
(12) Patent Application Publication
(10) Pub. No.: US 2026/0288533 A1
(43) Pub. Date: Sep. 24, 2026

(54) COMPUTING DEVICE, METHOD FOR LOAD DISTRIBUTION FOR SUCH A COMPUTING DEVICE AND COMPUTER SYSTEM

(71) Applicant: MERCEDES-BENZ GROUP AG, Stuttgart (DE)

(72) Inventor: Thorsten WILMER, Sindelfingen (DE)

(21) Appl. No.: 19/118,450

(22) PCT Filed: Sep. 18, 2023
(86) PCT No.: PCT/EP2023/075624

§ 371 Date: Apr. 4, 2025

(30) Foreign Application Priority Data
Oct. 5, 2022 (DE) 10 2022 003 661.4

(51) Int. Cl. G06F 9/50

(52) U.S. Cl. CPC G06F 9/5061

(57) ABSTRACT

A computing device includes a processor unit having a plurality of interacting computing cores and a plurality of memory elements assigned to the computing cores and at least one input interface for receiving information to be processed by the computing cores and at least one output interface for outputting information processed by the computing cores. The memory elements are formed by dual-port RAM, each processor core has exactly two inputs for receiving information and exactly one output for outputting information, wherein each input and each output is formed by a respective memory element and a physical distance from a respective processor core to the memory elements connected to the processor core is equidistant.

### BACKGROUND AND SUMMARY OF THE INVENTION

Exemplary embodiments of the invention relate to a computing device, as well as a method for load distribution for such a computing device and a computer system having such a computing device.

Processors represent elementary components of computer devices. Processors are available in various designs, such as central processing units for PCs, also known as CPUs for short, or as integrated circuits in the form of microprocessors and micro controllers in embedded systems. A CPU is characterized by comparatively few, however powerful computing cores. This makes it possible to execute comparatively complex and CPU-intensive programs. Parallelization of program sequences is similarly possible. CPUs are designed to solve a wide range of different types of tasks and problems.

Processors are also designed in the form of so-called graphic processors, abbr. GPU. In contrast to the CPU, modern GPUs are characterized by a plurality of computing cores in an order of magnitude of several thousand units per chip. These may be comparatively inefficient computing cores, which are optimized for solving a handful of special tasks. Mainly, GPUs are thus used for calculating matrices or tensors, for example for graphic calculations or for providing/accelerating artificial intelligence. GPUs are therefore suitable in particular for parallel processing of tasks.

Providing information to be processed by the processor core of the graphic processor, in particular the connection to a CPU, typically takes place via a bus system, such as PCI Express (PCIe). Processing the corresponding information by the processor cores of the graphic processor requires this information to be cached before, during, and after the processing. For this purpose, diverse processor-internal and processor-external memory elements (however arranged on a common printed circuit board) are known.

Typically, these memory elements are arranged inside or on a graphic processor in a two-dimensional structure. In this case, the individual components are typically distributed at a right angle. This leads to the physical distances between the processor cores and the interfaces used for transmitting information, for example the mentioned memory elements, bus connections and/or further processor cores, differing in length. Accordingly, more time is required to send the information through a correspondingly longer data line. As a result, latencies increase, whereby the graphic processor functions less efficiently.

A DDR 4-SSD dual-port DIMM device is known from US 2015/0255130 A1. It may be a device that can be used both as a working memory as well as a main memory, i.e., mass memory device such as a hard drive or SSD. The device can be connected to the bus system of a main board via an RAM socket or PCIe socket. Due to the design of the used memory elements as dual-port memory elements, a simultaneous write and read access to the device by two host systems is possible. The arrangement of the memory elements also takes place here along lines running parallel to each other or orthogonal to each other, i.e., quadratic or rectangular.

Additionally, it is conventional practice for a person skilled in the art to use a computing unit with a multi-core processor, in order to process several tasks in parallel and thus in a particularly efficient way, as documented by: Multi-core processor. In: Wikipedia, the free encyclopedia. Revision date: 4 Sep. 2022. URL: https://en.wikipedia.org/w/index.php?title=Multi-core_processor&oldid=1108514820.

The conventional connection of memory elements to the individual processor cores of a processor is familiar to those skilled in the art, for example from: CPU cache. In: Wikipedia, the free encyclopedia. Revision date: 30 Sep. 2022. URL: https://en.wikipedia.org/w/index.php?title=CPU_cache&oldid=1113266567. It is common practice to provide multi-level caches. Here, each processor core is assigned its own L1 cache. Several processor cores can use an L2 or also L3 cache together. A corresponding cache can be designed as a multi-ported cache.

Additionally, US 2009/0216924 A1 discloses an interconnection system, showing processor cores arranged to form a hexagonal honeycomb.

Such an arrangement of processor cores is also known from US 2020/0243154 A1.

Exemplary embodiments of the present invention are directed to an improved computing device characterized by increased computational efficiency.

A generic computing device, comprising a processor unit having a plurality of interacting processor cores and a plurality of memory elements assigned to the processor cores and at least one input interface for receiving information to be processed by the processor cores and at least one output interface for outputting information processed by the processor cores, is developed according to the invention in that the memory elements are formed by dual-port RAM, each processor core has exactly two inputs for receiving information and exactly one output for outputting information and is connected to exactly three memory elements, wherein the first two of these three memory elements each form one of the two inputs of the processor core and the third memory element forms the output of the processor core, the three memory elements are each arranged in a star shape at an angle of 120° to each other around the processor core, and a physical distance from a respective processor core to the memory elements connected to the processor core is equidistant.

The computing device according to the invention is based on the idea of organizing the physical distance of the memory connection of the respective processor cores in the same way, so that the distance between a respective processor core and the memory elements connected to it is of the same length. The time duration required to provide a processor core with the information to be processed or to discharge the processed information from a processor core is thus identical for each processor core. This increases the efficiency of the processor unit, as information is passed on from processor core to processor core at the same rate and thus a processor core that receives information from two processor cores upstream in the data flow direction does not have to wait, after receiving information from a first processor core, to receive information from a first processor core, as both pieces of information arrive simultaneously. This enables particularly fast data processing.

For example, the processor unit may be a central processing unit, abbr. CPU, or also a graphic processor, abbr. GPU. The computing device may be a corresponding chip or a circuit board or printed circuit board, such as a card, for example a graphics card. The base surface of the processor unit can be square or rectangular. Any polygonal surface shape is also possible. In particular, the processor cores are designed similarly and particularly preferably have the same geometric design, i.e., the same geometric shape and the same surface area.

The computing device can be integrated into a superordinate computer system. Further components of the computing device and/or of the corresponding computer system can also have direct memory access, i.e. write and/or read access to the input interface or the output interface. This is also referred to as direct memory access (DMA).

The individual processor cores can now process a fixed program depending on implementation, for example a program read out by a read-only memory (ROM), wherein the ROM can be a part of the computing device of also of the superordinate computer system, or the processor cores can read out and interpret information from a random-access memory (RAM), and thus execute code comprised of RAM as instructions.

As each processor core has two inputs and one output, each function to be processed can be performed directly in parallel, as each processor core can also read in two operands simultaneously.

Therefore, according to the invention a respective processor core and the memory elements forming its two inputs and its output are arranged in a star shape on the processor unit, wherein an angle between the respective memory elements is 120 degrees. Thus, a particularly effective distribution of the processor cores on the processor unit is possible. A symmetrical arrangement of the processor cores can be achieved while maintaining a solid angle of 120 degrees between said memory elements, and therefore the physical distance between the respective memory elements and processor cores can be made equidistant in a particularly simple manner.

Preferably, in each case six processor cores are arranged on the processor unit in the form of hexagonal honeycomb. This enables the solid angle of 120 degrees to the respective memory elements to be maintained for each processor core in a simple and reliable manner and the distance between processor cores and memory elements to be made the same. A further particular advantage is that the distance of corresponding data lines can be shortened compared to the embodiments known from the prior art, in particular a longest data line between a processor core and the memory element assigned to the processor core in a rectangular arrangement. Thus, the latencies in data processing can be further reduced.

Individual processor cores of one and the same hexagonal honeycomb can also be part of a neighboring hexagonal honeycomb at the same time. The distribution of the processor cores on the processor unit can be compared to the honeycomb in a beehive. Particularly preferably, then the processor unit also has a hexagonal honeycomb cross-section. On the one hand, the processor unit can be designed in a particularly compact manner as a result and on the other hand the individual processor cores can be sufficiently spaced apart from each other so that a sufficiently large surface area is available for heat dissipation. This improves the thermal management of the computing device so that particularly large and complex cooling devices can be omitted. Thus, cooling by means of passive or simple active cooling devices is possible.

A further advantageous embodiment of the computing device also provides that the at least one input interface and the at least one output interface are each formed by dual-port RAM and the at least one input interface forms an input of an input core arranged in a connecting chain of the processor cores at the perimeter of the connecting chain and the at least one output interface forms an output of an output core arranged at the perimeter of the connecting chain. The input interface and the output interface can be read or written by the processor unit. Furthermore, other components of the computing device or also of the computer system superordinate to the computing device can have write and/or read access to the input interface and the output interface. Due to the embodiment as a dual-port RAM, simultaneous write access or simultaneous read access by the processor unit and another corresponding component is possible.

Preferably, the at least one input interface and the at least one output interface are arranged on two opposing sides of the processor unit. To solve a task, i.e., to process information, for example by executing a program, information is processed by the processor cores of the processor unit. For this purpose, the processor unit is provided with information via the input interface and the processed information is output at the output interface. It is a directed graph, along which information is passed on through the connecting chain of the processor cores. If the input interface and the output interface are arranged on the two end points of the directed graph, a particularly simple directed graph that can thus be moved through quickly can be constructed.

A further advantageous embodiment of the computing device also provides that the computing device has at least one second input interface and/or at least one second output interface. Thus, information can be supplied into or discharged from the data flow graphs provided by the processor cores at several points. As a result, the parallelization of several tasks to be processed is facilitated by the processor unit. Access to the further input interfaces or output interfaces is also possible by means of DMA.

According to a further advantageous embodiment of the computing device, the at least one second input interface and/or the at least one second output interface is/are arranged on a different side on the processor unit than the first input interface and the first output interface. The construction of the computing device according to the invention enables information to pass through the connecting chain of the processor cores, i.e., the corresponding directed data flow graph, not only in a one-dimensional manner along a line, but also in a two-dimensional manner. Then, information can also be introduced into or discharged from this at the center or at another intermediate point on the corresponding data flow graph. On the one hand, this enables handling of particularly complex programs and on the other hand this enables large-scale parallelization, as several tasks that are comparatively simple to solve require distribution to fewer processor cores and thus not all processor cores of the data flow graph have to be involved in one and the same task. As a result, corresponding other processor cores are available for solving further tasks.

Inside the connecting chain of the processor cores in the processor unit, “islands” of joined-up processor cores can arise, wherein different tasks are handled on each island. Then, an individual information supply and discharge is possible for each island due to the additional laterally arranged input and output interfaces. These islands can also be referred to as groups or clusters.

The geographical division of the processor cores grouped into islands on the processor unit is based on the complexity of the respective tasks. Complex tasks that require comparatively many processor cores can be geographically outsourced to a central area of the processor unit, as a connection to input and output interfaces is remote here, which is therefore particularly suitable for tasks in which no new information needs to be fed into the processor chain for a relatively long time or a large number of mathematical operations and the result only needs to be provided at the end. Simpler tasks can then be distributed accordingly to processor islands, which are distributed more in the edge region of the processor unit. This enables simply supply and discharge of information via the input and output interfaces.

An advantageous further development of the computing device according to the invention also provides that all processor cores operate at a substantially identical rate. Therefore, the efficiency of the computing device according to the invention can be further increased. As already explained above, the corresponding data lines for passing information on in the connecting chain of the processor cores are the same length, so that information is exchanged between processor cores at the same speed. If the processor cores themselves also need the same amount of time to process the information to solve a task due to an essentially identical rate, the latencies in data processing can be reduced even further by the processor unit. If a processor core therefore requires information from two upstream processor cores, these two upstream processor cores receive input data simultaneously, process it simultaneously and also make it available to the processing core for further processing at the same time.

Preferably, the processor cores are set up to alternate between a sleep mode and an active mode, wherein a respective processor core does not process any information in sleep mode and information can be processed in the active mode. As a result, the energy efficiency of the processor unit can be improved. Depending on the complexity of the task to be processed, it can be necessary to involve a specific number of processor cores in the task. If no runtime gain is possible by involving additional processor cores or if no further tasks need to be solved, individual processor cores of the processor unit can be put into sleep mode. As these processor cores are then no longer ‘operated’, the energy consumption of the processor unit can be reduced.

According to the invention, a method for load distribution for a computing device described above provides that a compiler determines a data flow graph that can be used by concatenation of the processor cores of the processor unit and distributes the load distribution of the information to be processed by the processor cores to solve a task to the individual processor cores by applying pattern matching as a function of the determined data flow graph. This enables a particularly even and therefore efficient load distribution to be achieved. Accordingly, programs can be executed in a particularly short runtime, which further improves the effectiveness of the computing device according to the invention. Since two inputs and one output are assigned to each processor core, when the processor cores are arranged in hexagonal honeycombs, two inputs of two neighboring processor cores sometimes overlap. This situation is taken into account by the compiler when determining the data flow graph so that information is not passed on in one direction by the data flow graph at this point. As the individual memory elements are designed as dual-port RAM, reading and writing is possible from both sides. Two processor cores connected to each other via inputs can thus be used to pass on information in a circuit in the connecting chain of the processor cores. This further improves the efficiency of the computing device according to the invention, as no unused processor cores remain when processing information.

According to the invention, a computing device as described above is integrated into a computer system. The computer system may, for example, be a PC, an embedded system or another information technology system. The computing device according to the invention can, for example, be designed as a plug-in card for a mainboard of a PC. All common variants are possible as a plug-in connection and corresponding information transmission protocol. For example, it is a PCIe interface. The computer system can also be formed by a vehicle or a vehicle-integrated computing unit. The computing device according to the invention can be used, in particular, in connection with a vehicle to accelerate artificial intelligence, for example using artificial neural networks. The computing device according to the invention can thus be integrated into a vehicle to provide automated or even autonomous driving functions.

Further advantageous embodiments of the computing device according to the invention result from the exemplary embodiments which are described in more detail below with reference to the figures.

### BRIEF DESCRIPTION OF THE DRAWING FIGURES

Here:

FIG. 1 shows a schematic illustration of a processor core with its respective inputs and output formed by dual-port RAM;

FIG. 2 shows a schematic illustration of a section of several processor cores connected to each other to form a connecting chain in the form of hexagonal honeycomb; and

FIG. 3 shows a schematic illustration of a computing device according to the invention.

### DETAILED DESCRIPTION

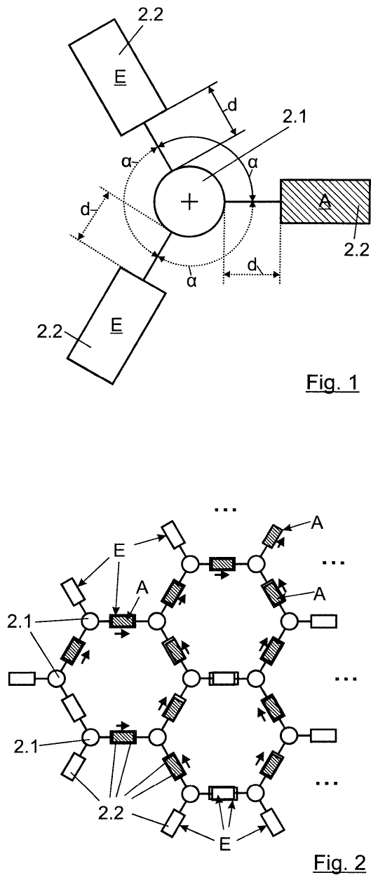

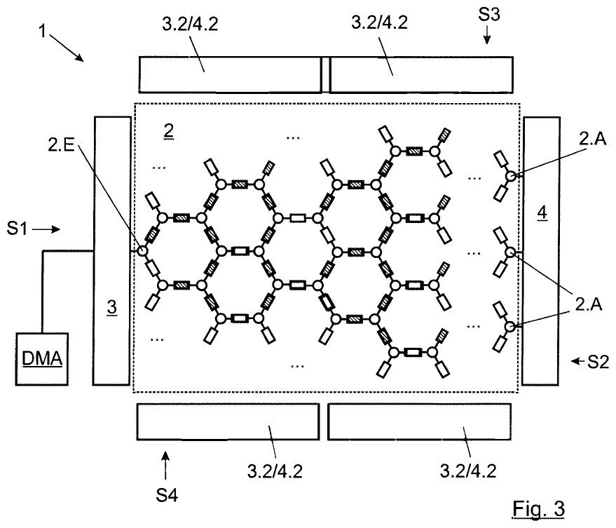

FIG. 1 illustrates the relative arrangement, according to the invention, of processor cores 2.1 and memory elements 2.2 of a processor unit 2 of a computing device 1 according to the invention shown in FIG. 3. The exact form of the processor cores 2.1 and the memory elements 2.2 is only to be understood as symbolic here. The processor cores 2.1 can also have a geometry differing from a circular shape and the memory elements 2.2 can also have a geometry differing from the rectangular shape.

Each processor core 2.1 of the processing unit 2 is connected to exactly three dual-port RAMs. In this case, two of these memory elements 2.2 form an input E for supplying information to the respective processor core 2.1 and a memory element 2.2 forms an output A for discharging the information processed by the processor core 2.1.

As can be seen from FIG. 1, the memory elements 2.2 are arranged in a star shape at an angle α of 120° around a respective processor core 2.1. A distance d between the processor core 2.1 and a respective memory element 2.2 is designed to be equidistant. The distance d is thus the same for each memory element 2.2 shown in FIG. 1. Furthermore, according to the embodiment shown in FIG. 1, all the memory elements 2.2 are the same length, in particular they have the same geometric design. This enables a symmetrical arrangement of the processor cores 2.1 and memory elements 2.2 on the processor unit 2 according to a specific pattern represented in FIG. 2.

FIG. 2 thus illustrates the arrangement of several of said processor cores 2.1 and memory elements 2.2. The processor cores 2.1 and memory elements 2.2 are connected to each other in the form of hexagonal honeycomb, in order to construct a data flow graph. This construction has the advantage that the length of a data line is the same length between each memory element 2.2 and adjacent processor core 2.1, whereby the same time duration is always required to transmit information from a memory element 2.2 to a processor core 2.1. Additionally, processor cores 2.1 can thus simultaneously read in two different pieces of information, for example different variables, which aids parallelization, i.e., simultaneous processing of different tasks.

In particular, all processor cores 2.1 calculate at the same rate, which enables even more efficient data processing. In particular, information is provided to the individual processor cores 2.1 simultaneously and processed by these simultaneously. Accordingly, information is provided simultaneously from the processor core 2.1 via a respective output A and can be simultaneously provided to the respective following processor core 2.1 via its respective inputs E. The corresponding network or data flow graph formed by this concatenation of processor cores 2.1 can be iterated in a particularly efficient way.

It is indicated in FIG. 2 by dots “ . . . ” that the network of processor cores 2.1 and memory elements 2.2 spreads out further with a corresponding design. Additionally, the data flow direction at the respective outputs A is symbolized by a small arrow, in order to better illustrate which output A is assigned to which processor core 2.1. For the sake of clarity, not all elements are labelled with reference signs.

FIG. 3 shows the computing device 1 again in more comprehensive illustration. Here, only the essential components are shown. Typical components, such as memory controllers for example, are not shown. FIG. 3 shows an input interface 3 arranged on a first side S1 and an output interface 4 opposite the processor unit 2 on a second side S2. The input interface 3 and the output interface 4 are in particular similarly formed by dual-port RAM. This enables simultaneous read and write access to the input interface 3 and the output interface 4 both via the processor unit 2 and a computing unit superordinate to the computing device 1. This superordinate computing unit or computer system can have a direct memory access DMA on the interfaces, for example on the input interface 3 as represented in FIG. 3. A corresponding computer system then does not have to take a detour via a main processor such as a CPU to control the computing device 1, but rather information can be provided directly to the computing device 1 without detouring via the CPU. This further improves the runtime of tasks, i.e., programs, to be executed.

The processor cores 2.1 arranged on the edge of the connecting chain of the processor cores 2.1, i.e., at the perimeter, can be connected directly, i.e. without an intermediate memory element 2.2., to the respective input interface 3 or output interface 4, as shown in FIG. 3. A processor core 2.1 connected directly to the input interface 3 is also referred to as an input core 2.E and a processor core 2.1 connected directly to the output interface 4 is also referred to as an output core 2.A. Any number of processor cores 2.1 can be connected to the input interface 3 or output interface 4, for example, in each case one, two, three or four or also more processor cores 2.1.

Furthermore, the computing device 1 can feature at least one second input interface 3.2 and/or at least one second output interface 4.2. In particular, the second input interface 3.2 and the second output interface 4.2 are arranged on sides S3, S4 differing from the first and second side S1, S2. Several second input interfaces 3.2 or output interfaces 4.2 can also be provided on the same side. This also facilitates providing or discharging information in a middle region of the connecting chain of the processor cores 2.1. The connecting chain of the processor cores 2.1 is similarly connected to the respective second input interface 3.2 and the second output interface 4.2 via input cores 2.E and output cores 2.A (not shown).

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A computing device comprising:
a processor unit comprising a plurality of interacting processor cores and a plurality of memory elements assigned to the plurality of interacting processor cores;
at least one input interface configured to receive information to be processed by the plurality of interacting processor cores; and
at least one output interface configured to output information processed by the plurality of interacting processor cores,
wherein the plurality of memory elements are dual-port RAM,
wherein each of the plurality of interacting processor cores has exactly two inputs configured to receive information and exactly one output configured to output for outputting information,
wherein each of the plurality of interacting processor cores is connected to exactly three memory elements of the plurality of memory elements,
wherein a first two of the exactly three memory elements each form one of two inputs of the processor core and a third memory element of the exactly three memory elements forms the output of the processor core,
wherein the exactly three memory elements are each arranged in a star shape at an angle of 120° to each other around the processor core, and
wherein a physical distance of a data line connecting the exactly three memory elements with the respective processor core is equidistant.

12. The computing device of claim 11, wherein the plurality of interacting processing cores comprises six processor cores arranged on the processor unit in a form of a hexagonal honeycomb.

13. The computing device of claim 11, wherein the at least one input interface and the at least one output interface are each dual-port RAM, wherein the at least one input interface forms an input of an input core arranged in a connecting chain of the plurality of interacting processor cores at a perimeter of the connecting chain, and wherein the at least one output interface forms an output of an output core arranged at the perimeter of the connecting chain.

14. The computing device of claim 11, wherein the at least one input interface and the at least one output interface are arranged on two opposing sides of the processor unit.

15. The computing device of claim 11, further comprising:
at least one second input interface or at least one second output interface.

16. The computing device of claim 15, wherein the at least one second input interface or the at least one second output interface is arranged on a different side on the processing unit than the at least one first input interface and the at least one first output interface.

17. The computing device of claim 11, wherein all processor cores of the plurality of interacting processor cores work at a substantially identical rate.

18. The computing device of claim 11, wherein the plurality of interacting processor cores are configured to alternate between a sleep mode and an active mode, wherein a respective processor core of the plurality of interacting processor cores does not process any information in sleep mode and information can be processed in the active mode.

19. A method for load distribution for a computing device, wherein the computing device comprises a processor unit comprising a plurality of interacting processor cores and a plurality of memory elements assigned to the plurality of interacting processor cores; at least one input interface configured to receive information to be processed by the plurality of interacting processor cores; and at least one output interface configured to output information processed by the plurality of interacting processor cores, wherein the plurality of memory elements are dual-port RAM, wherein each of the plurality of interacting processor cores has exactly two inputs configured to receive information and exactly one output configured to output for outputting information, wherein each of the plurality of interacting processor cores is connected to exactly three memory elements of the plurality of memory elements, wherein a first two of the exactly three memory elements each form one of two inputs of the processor core and a third memory element of the exactly three memory elements forms the output of the processor core, wherein the exactly three memory elements are each arranged in a star shape at an angle of 120° to each other around the processor core, and wherein a physical distance of a data line connecting the exactly three memory elements with the respective processor core is equidistant, the method comprising:
determining, by a compiler, a data flow graph that can be used by concatenation of the plurality of interacting processor cores of the processor unit; and
distributing, by the compiler, the load distribution of the information to be processed by the plurality of interacting processor cores for solving a task to individual processor cores of the plurality of interacting processor cores by applying pattern matching as a function of the determined data flow graph.

20. A computer system comprising:
at least one computing device, which comprises
a processor unit comprising a plurality of interacting processor cores and a plurality of memory elements assigned to the plurality of interacting processor cores;
at least one input interface configured to receive information to be processed by the plurality of interacting processor cores; and
at least one output interface configured to output information processed by the plurality of interacting processor cores,
wherein the plurality of memory elements are dual-port RAM,
wherein each of the plurality of interacting processor cores has exactly two inputs configured to receive information and exactly one output configured to output for outputting information,
wherein each of the plurality of interacting processor cores is connected to exactly three memory elements of the plurality of memory elements,
wherein a first two of the exactly three memory elements each form one of two inputs of the processor core and a third memory element of the exactly three memory elements forms the output of the processor core,
wherein the exactly three memory elements are each arranged in a star shape at an angle of 120° to each other around the processor core, and
wherein a physical distance of a data line connecting the exactly three memory elements with the respective processor core is equidistant.
